(19) United States
(12) Patent Application Publication
(10) Pub. No.: US 2026/0021611 A1
(43) Pub. Date: Jan. 22, 2026

(54) VARIABLE PRESSURE CONTROLLED INJECTION METHOD, SEMI-FINISHED INJECTION PRODUCT, AND CO-INJECTION PRODUCT MANUFACTURING METHOD

(71) Applicant: CHANG YANG MATERIAL CORP., Changhua County (TW)

(72) Inventors: Ming-Hua HUANG, Changhua County (TW); Shun-Fan LEE, Changhua County (TW); Kuo-An WANG, Changhua County (TW); Tsung-Wei KUO, Changhua County (TW); Chien Jung HUNG, Changhua County (TW); Chun Che HUANG, Changhua County (TW); Jia Lung LIN, Changhua County (TW)

(21) Appl. No.: 19/256,176

(22) Filed: Jul. 1, 2025

(30) Foreign Application Priority Data
Jul. 16, 2024 (CN) 202410950566.4

(51) Int. Cl. B29C 44/04; B29C 44/58; B29C 44/60; B29K 101/12; B29L 31/50

(52) U.S. Cl. CPC B29C 44/0415; B29C 44/58; B29C 44/60; B29K 2101/12; B29L 2031/504

(57) ABSTRACT

A variable pressure controlled injection method, a semi-finished injection product, and a co-injection product manufacturing method are provided. The variable pressure controlled injection method includes providing an injection molding system, injecting a first foaming material, and performing a foaming step. The injection molding system includes a first variable pressure mold and a second variable pressure mold. In the foaming step, the first variable pressure mold and the second variable pressure mold apply a first pressure and a second pressure to the first foaming material respectively, and then the first foaming material is heated to form a semi-finished injection product. The semi-finished injection product includes a microporous layer and a solidified layer. The co-injection product manufacturing method includes injecting a second foaming material onto the semi-finished injection product and heating under a stable internal pressure to complete foam and obtain a co-injection product.

### RELATED APPLICATIONS

This application claims priority to China Application Serial Number 202410950566.4, filed Jul. 16, 2024, which is herein incorporated by reference.

### BACKGROUND

### Technical Field

The present disclosure relates to an injection method, a semi-finished injection product, and a co-injection product manufacturing method. More particularly, the present disclosure relates to a variable pressure controlled injection method, a semi-finished injection product, and a co-injection product manufacturing method.

### Description of Related Art

Shoes are primarily used to protect the feet and prevent the feet from being stabbed by sharp objects when stepping on the ground. Shoes conventionally include an upper structure and a sole structure. The upper structure can be made from any suitable material to cover, fix and support the foot on the sole structure. The sole structure is usually a layered configuration extending between the ground surface and the upper structure, including an outsole that provides wear resistance and traction with the ground surface, and a midsole arranged between the outsole and the upper structure.

The outsole, which needs to be slip-resistant, wear-resistant and elastic, is usually made of materials such as rubber or genuine leather to enhance traction with the ground surface. The midsole, designed to provide cushioning for the foot, is typically at least partially made of polymer foam material, which can be elastically compressed under load to cushion the force borne by the foot by reducing the reaction force of the ground. In conventional manufacturing processes, the midsole and the outsole of the sole structure need to undergo steps such as roughening, washing, drying, surface treating with a treatment agent, drying, gluing, and drying again before bonding. However, since the outsole and the midsole are made of different materials, the expansion degree, softness, hardness or density of the heterogeneous materials are different, resulting in the conventional sole structure having problems such as poor durability, easy damage and easy detachment of the outsole from the midsole.

Additionally, the volatile organic compounds commonly used in the gluing step of the sole structure manufacturing process are also likely to cause harm to human body and the environment. Therefore, developing a method to tightly bond the heterogeneous materials in the sole structure without adding an adhesive is a development goal with commercial valuable.

### SUMMARY

According to one embodiment of the present disclosure, a variable pressure controlled injection method includes steps as follows. An injection molding system is provided. The injection molding system includes a first variable pressure mold and a second variable pressure mold, and the first variable pressure mold and the second variable pressure mold are disposed opposite to each other corresponding to a foaming molding space. The first variable pressure mold and the second variable pressure mold respectively include a mold body and a variable pressure porous layer. The variable pressure porous layer is disposed on the mold body and correspondingly exposed to the foam molding space, wherein a plurality of variable pressure pores are disposed in the variable pressure porous layer, and the variable pressure pores connect the foam molding space. A first foaming material is injected to the foam molding space. A foaming step is performed, wherein the first variable pressure mold applies a first pressure to the first foaming material, the second variable pressure mold applies a second pressure to the first foaming material, and then the first foaming material is heated to form a semi-finished injection product. The first pressure and the second pressure are different, and the first pressure is a varying pressure.

According to another embodiment of the present disclosure, a semi-finished injection product is manufactured by the aforementioned variable pressure controlled injection method. The semi-finished injection product includes a microporous layer and a solidified layer, the microporous layer is formed at one end of the semi-finished product near the first variable pressure mold, and the solidified layer is formed at one end of the semi-finished product near the second variable pressure mold.

According to another embodiment of the present disclosure, a co-injection product manufacturing method includes steps as follows. The aforementioned semi-finished injection product is provided. A second foaming material is injected onto the microporous layer of the semi-finished product to obtain a co-injection preform. A molding step is performed, wherein the co-injection preform is heated under a stable internal pressure to completely foam and obtain a co-injection product.

### BRIEF DESCRIPTION OF THE DRAWINGS

The present disclosure can be more fully understood by reading the following detailed description of the embodiment, with reference made to the accompanying drawings as follows:

FIG. 1 is a step flow chart of a variable pressure controlled injection method according to one embodiment of the present disclosure.

FIG. 2 is a schematic view showing the process of a foaming step in the variable pressure controlled injection method of FIG. 1.

FIG. 3 is a partial schematic view showing the process of the foaming step in the variable pressure controlled injection method of FIG. 1.

FIG. 4 is a schematic view of a semi-finished injection product according to another embodiment of the present disclosure.

FIG. 5 is a step flow chart of a co-injection product manufacturing method according to one another embodiment of the present disclosure.

FIG. 6 is a schematic view of a co-injection product manufactured by the co-injection product manufacturing method according to one another embodiment of the present disclosure.

FIG. 7 is a cross-sectional view of the co-injection product along sectional line 7-7 in FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. Moreover, for the sake of simplicity, some conventional structures and components will be depicted schematically in the drawings and repetitive components can be represented by the same reference numbers.

It should be noted that certain terms in the specification and claims of the present disclosure are preceded by “first”, “second”, “third”, “fourth”, “fifth” or “sixth”, which are used to distinguish different terms from each other. If the terms are not specifically described as having a sequence, or if the context does not indicate a sequence, the order of the terms is not limited by the preceded “first”, “second”, “third”, “fourth”, “fifth” or “sixth”.

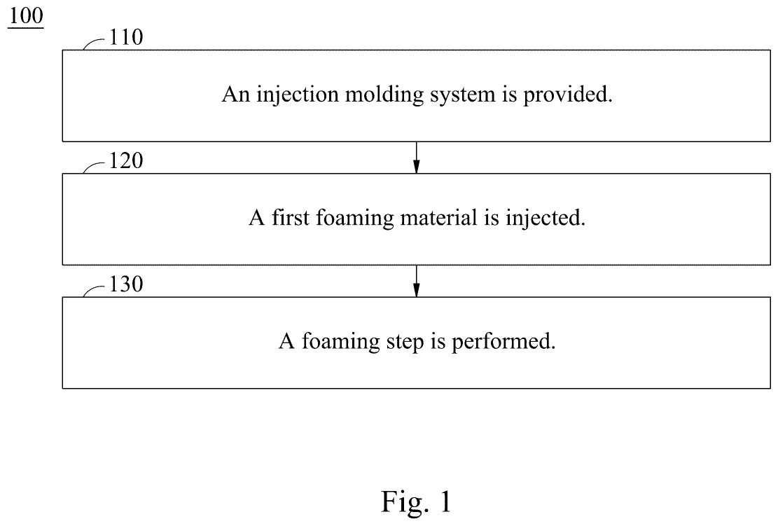

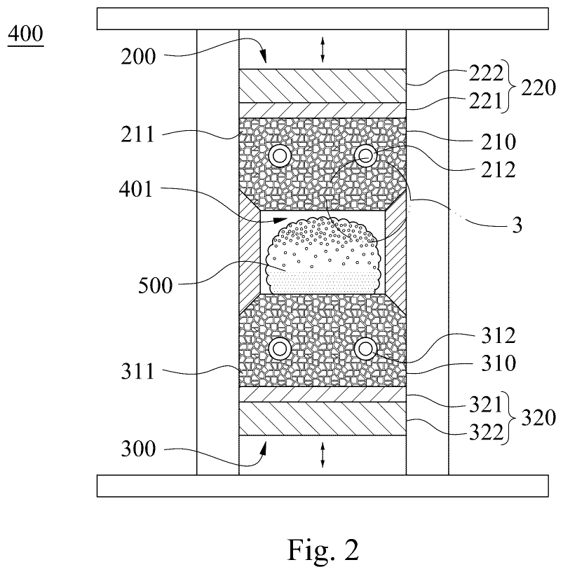

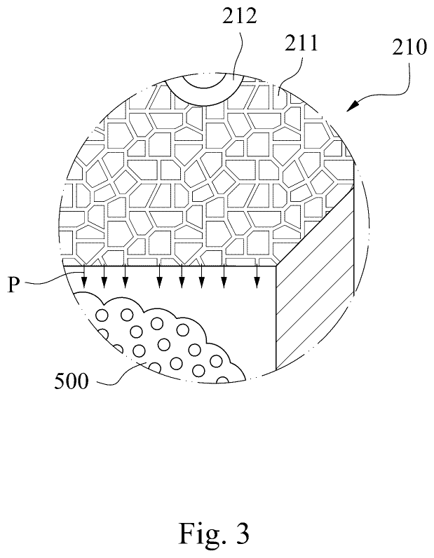

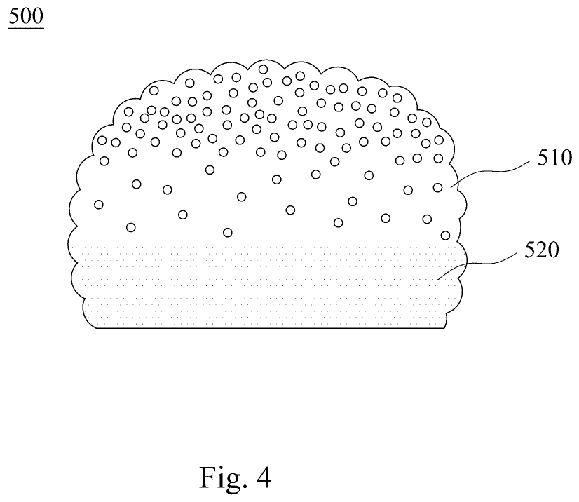

Reference is made to FIG. 1, FIG. 2, FIG. 3 and FIG. 4. FIG. 1 is a step flow chart of a variable pressure controlled injection method 100 according to one embodiment of the present disclosure. FIG. 2 is a schematic view showing the process of a foaming step in the variable pressure controlled injection method 100 of FIG. 1. FIG. 3 is a partial schematic view showing the process of the foaming step in the variable pressure controlled injection method 100 of FIG. 1. FIG. 4 is a schematic view of a semi-finished injection product 500 according to another embodiment of the present disclosure. In FIG. 1, the variable pressure controlled injection method 100 includes Step 110, Step 120 and Step 130.

In Step 110, an injection molding system 400 is provided. The injection molding system 400 includes a first variable pressure mold 200 and a second variable pressure mold 300, and the first variable pressure mold 200 and the second variable pressure mold 300 are disposed opposite to each other corresponding to a foaming molding space 401. The first variable pressure mold 200 includes a mold body 220 and a variable pressure porous layer 210. The variable pressure porous layer 210 is disposed on the mold body 220 and correspondingly exposed to the foam molding space 401, wherein a plurality of variable pressure pores 211 are disposed in the variable pressure porous layer 210, and the variable pressure pores 211 connect the foam molding space 401. A cooling tube 212 can be buried in the variable pressure porous layer 210. The second variable pressure mold 300 includes a mold body 320 and a variable pressure porous layer 310. The variable pressure porous layer 310 is disposed on the mold body 320 and correspondingly exposed to the foam molding space 401, wherein a plurality of variable pressure pores 311 are disposed in the variable pressure porous layer 310, and the variable pressure pores 311 connect the foam molding space 401. A cooling tube 312 can be buried in the variable pressure porous layer 310. Furthermore, a diameter of each of the plurality of variable pressure pores 211 of the first variable pressure mold 200 can be 200 μm to 700 μm, and the variable pressure pores 211 can be unevenly distributed in a mesh pattern or evenly arranged in parallel. A diameter of each of the plurality of variable pressure pores 311 of the second variable pressure mold 300 is 200 μm to 700 μm, and the variable pressure pores 311 can be unevenly distributed in a mesh pattern or evenly arranged in parallel. The mold body 220 of the first variable pressure mold 200 can include a solid layer 221 and a base 222, in which the solid layer 221 is disposed on inner side of the base 222 and the variable pressure porous layer 210 is disposed on inner side of the solid layer 221. The mold body 320 of the first variable pressure mold 300 can include a solid layer 321 and a base 322, in which the solid layer 321 is disposed on inner side of the base 322 and the variable pressure porous layer 310 is disposed on inner side of the solid layer 321.

In Step 120, a first foaming material is injected to the foam molding space 401. The first foaming material can be a rubber and plastic foaming material, for example, the first foaming material can be thermoplastic polyurethane (TPU), ethylene vinyl acetate (EVA), synthetic rubber, thermoplastic elastomer (TPE), thermoplastic vulcanizates (TPV), thermoplastic polyester elastomer (TPEE), polyether block amide (PEBAX), TPU/TPV, TPV/TPU/rubber or TPEE/TPV.

In Step 130, a foaming step is performed. The first variable pressure mold 200 applies a first pressure P to the first foaming material, and the second variable pressure mold 300 applies a second pressure to the first foaming material. Then the first foaming material is heated to form a semi-finished injection product 500. The first pressure P and the second pressure are different, and the first pressure P is a varying pressure. Furthermore, the first pressure can be applied as a third pressure for a duration of 1 second to 5 seconds before being increased to a fourth pressure, or applied as a fifth pressure for a duration of 1 second to 5 seconds before being decreased to a sixth pressure. The third pressure is less than the fourth pressure, and the fifth pressure is greater than the sixth pressure. Preferably, the third pressure can be 5 bar to 30 bar, and the fourth pressure can be 10 bar to 90 bar. For example, after applying the third pressure of 5 bar for 1 second to 5 seconds, the pressure is increased to the fourth pressure of 60 bar. The fifth pressure can be 10 bar to 90 bar, and the sixth pressure can be 5 bar to 30 bar. For example, after applying the fifth pressure of 30 bar for 1 second to 5 seconds, the pressure is decreased to the sixth pressure of 5 bar. Because the first pressure P applied by the first variable pressure mold 200 is a varying pressure, it will affect the foaming degree of the first foam material, thereby forming a microporous layer 510 at one end of the semi-finished injection product 500 near the first variable pressure mold 200. The foaming degree of the microporous layer 510 can be 30% to 80%, and the first pressure P can be adjusted according to the desired foaming degree. The second pressure can be a fixed pressure; preferably the second pressure can be 5 bar to 80 bar. Since the second pressure applied by the second variable pressure mold 300 is a fixed pressure, the first foam material can be stably foamed, thereby forming a solidified layer 520 at one end of the semi-finished injection product 500 near the second variable pressure mold 300. The foaming degree of the solidified layer 520 can be 50% to 100%.

Furthermore, the second pressure applied by the second variable pressure mold 300 can also be a varying pressure, so that the end of the semi-finished injection product 500 near the second variable pressure mold 300 is also in a state of low foaming degree. The second pressure can be adjusted according to the desired foaming degree.

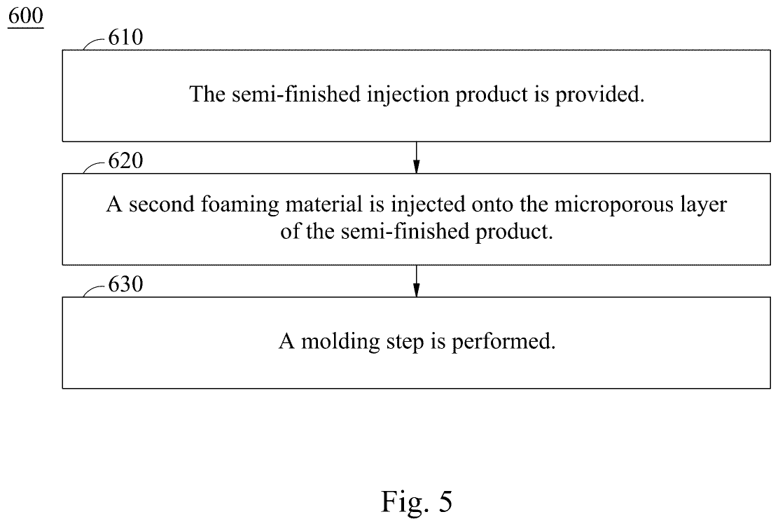

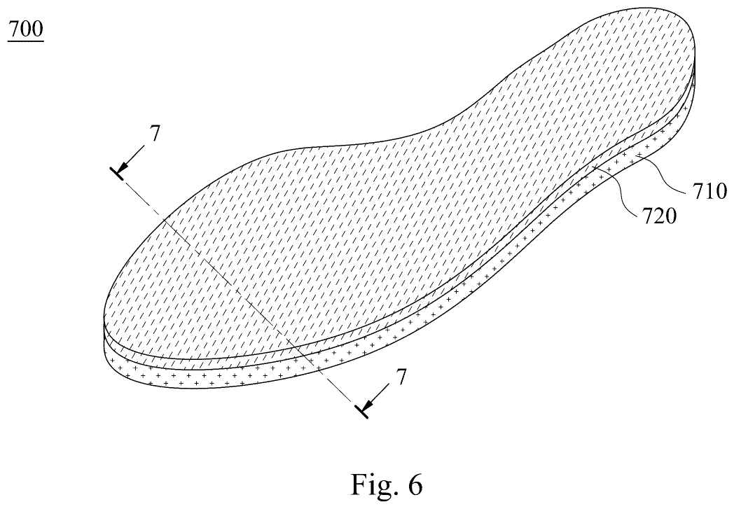

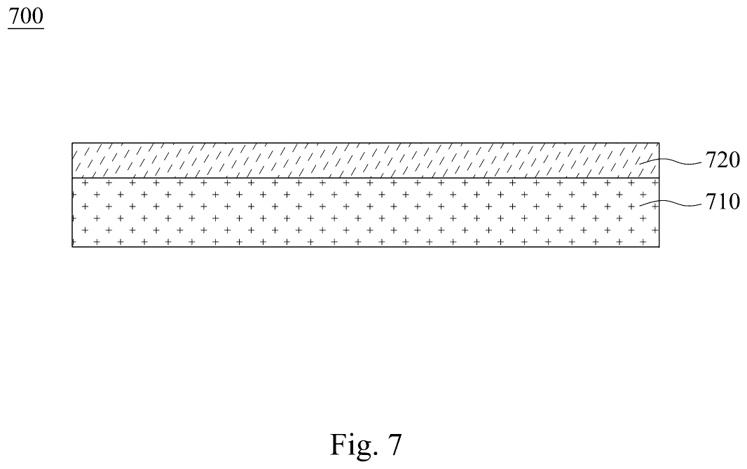

Reference is made to FIG. 5, FIG. 6 and FIG. 7. FIG. 5 is a step flow chart of a co-injection product manufacturing method 600 according to one another embodiment of the present disclosure. FIG. 6 is a schematic view of a co-injection product 700 manufactured by the co-injection product manufacturing method 600 according to one another embodiment of the present disclosure. FIG. 7 is a cross-sectional view of the co-injection product 700 along sectional line 7-7 in FIG. 6. In FIG. 5, the co-injection product manufacturing method 600 includes Step 610, Step 620 and Step 630.

In Step 610, the semi-finished injection product 500 is provided. The semi-finished injection product 500 includes a microporous layer 510 and a solidified layer 520. A foaming degree of the microporous layer 510 can be 30% to 80%, and a foaming degree of the solidified layer 520 can be 50% to 100%.

In Step 620, a second foaming material is injected onto the microporous layer 510 of the semi-finished product 500 to obtain a co-injection preform. The second foaming material can be a thermoplastic material, for example, the second foaming material can be thermoplastic polyurethane (TPU), thermoplastic polyester elastomer (TPEE) or polyether block amide (PEBAX).

In Step 630, a molding step is performed. The co-injection preform is heated under a stable internal pressure to completely foam and obtain a co-injection product 700. Specifically, the co-injection preform is heated to 30° C. to 100° C. under a stable internal pressure of 10 bar to 90 bar to fully foam the co-injection preform. Due to the presence of incompletely foamed bubbles and micropores in the microporous layer 510 of the semi-finished injection product 500, the contact surface between the microporous layer 510 and the second foam material has a roughening effect. The second foam material can dissolve into the microporous layer 510 of the semi-finished injection product 500 after heating and undergo secondary foaming. Therefore, the first material 710 after complete foaming of the first foaming material and the second material 720 after complete foaming of the second foaming material can be tightly bonded without the adhesive to obtain the co-injection product 700.

As shown in FIG. 6 and FIG. 7, the co-injection product 700 can be a shoe material, with the first material 710 as the outsole and the second material 720 as the midsole. The shoe material produced by the co-injection product manufacturing method 600 can tightly bond the outsole and the midsole, thereby improving the problem of the outsole easily detaching from the midsole and reducing environmental pollution caused by the roughening and gluing processes in the sole structure manufacturing process, which require chemical solvents for cleaning and consume a large amount of water resources. Depending on the needs, the first material 710 can also be the first midsole, and the second material 720 can be the second midsole. Furthermore, the co-injection product 700 can further include a third foaming material, or a carbon fiber board or plastic board can be included between the second foaming material and the semi-finished injection product 500. The carbon fiber board or plastic board can be coated between the first material 710 and the second material 720 by the co-injection product manufacturing method 600, for example, coated in the middle layer of the midsole of the shoe material. The first material 710 and the second material 720 can be the same or different, but the present disclosure is not limited thereto.

### Example

To demonstrate the bonding effect of the first material and the second material in the co-injection product manufactured by the co-injection product manufacturing method of the present disclosure, the first foaming material used in the test is TPV/TPU/rubber with a Shore hardness A of 60±3, and different first pressures are applied in the foaming step to obtain the semi-finished injection products of Comparative Example, Example 1, and Example 2. In Comparative Example 1, the first pressure for foaming the semi-finished injection product is 1 atm. In Example 1, the first pressure for foaming the semi-finished injection product is applied as the third pressure of 30 bar for the duration of 1 second to 5 seconds, then increased to the fourth pressure of 60 bar. In Example 2, the first pressure for foaming the semi-finished injection product is applied as the fifth pressure of 60 bar for the duration of 1 second to 5 seconds, then decreased to the sixth pressure of 30 bar. The second foaming material used is a thermoplastic material with a Shore hardness C of 25 to 65, which is injected into the semi-finished injection products of Comparative Example, Example 1, and Example 2, respectively, and the molding step is carried out to obtain the co-injection products of Comparative Example, Example 1, and Example 2 (hereinafter referred to as Comparative Example, Example 1, and Example 2). In Comparative Example, the first material and the second material are bonded with the adhesive. The bonding strength of the first material and the second material in Comparative Example, Example 1, and Example 2 is evaluated according to ASTM D186. In the ASTM D186 standard, a 10 mm wide test piece is used for testing, and a tensile strength of greater than or equal to 3.5 kg is considered qualified. The test is also conducted to observe whether the second material is torn apart from the first material. The second material must be torn to be considered qualified for bonding strength. The test results are shown in Table 1.

TABLE 1

| | Comparative | | |
|---|---|---|---|
| | Example | Example 1 | Example 2 |
| First pressure | 1 atm | 30 bar→ 60 bar | 60 bar→ 30 bar |
| Shore A hardness | 72 | 64 | 64 |
| Weight (g) | 41 | 36 | 35 |
| Tensile strength | 0.8~1.5 | 3.5~4.5 | 3.5~4.5 |
| (kg) | | or above | or above |
| Appearance | No material | Material torn | Material torn |
| | torn | | |

From the results in Table 1, the tensile strength values of Example 1 and Example 2 can both reach 3.5-4.5 kg or above, which are significantly higher than the tensile strength value of the Comparative Example, indicating that the first material and the second material in Example 1 and Example 2 are tightly bonded. The appearance of material torn can be observed in Example 1 and Example 2, while no material torn is observed in Comparative Example, indicating that the bonding strength of the first material and the second material in Example 1 and Example 2 is qualified. In addition, Example 1 and Example 2 do not need to be bonded with the adhesive. Furthermore, the first pressure is the varying pressure, so that the microporous layer of the semi-finished injection product in Example 1 and Example 2 has micropores. Therefore, compared with the weight of Comparative Example, the weight of Example 1 and Example 2 can be significantly reduced, from 41 g of the Comparative Example to 36 g of Example 1 and 35 g of Example 2, respectively, with a reduction of approximately 12% and 15%.

In summary, the present disclosure has the following advantages. First, the variable pressure controlled injection method of the present disclosure applies the first pressure and the second pressure to the first foaming material respectively. Since the first pressure and the second pressure are different and the first pressure is the varying pressure, the semi-finished injection product with the microporous layer and the solidified layer can be obtained, and the foaming degrees of the microporous layer and the solidified layer are different. Second, the co-injection product manufacturing method of the present disclosure heats the semi-finished injection product having the microporous layer and the solidified layer and the second foaming material under a stable internal pressure to completely foam and obtain the co-injection product. The co-injection product can form a tight bond of heterogeneous materials without adding the adhesive, and the connection between the first material after complete foaming of the first foaming material and the second material after complete foaming of the second foaming material is smooth and beautiful, so that the co-injection product has an integrated molding effect and can effectively save production costs. In addition, the bonding strength of the first material and the second material in the co-injection product is significantly better than that of the Comparative Example bonded with the adhesive. Third, the microporous layer of the semi-finished injection product manufactured by the variable pressure controlled injection method of the present disclosure can greatly reduce the weight of the co-injection product manufactured by the co-injection product manufacturing method of the present disclosure due to the presence of micropores, thereby achieving a lightweight effect.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A variable pressure controlled injection method, comprising:
providing an injection molding system comprising a first variable pressure mold and a second variable pressure mold, wherein the first variable pressure mold and the second variable pressure mold are disposed opposite to each other corresponding to a foaming molding space, and the first variable pressure mold and the second variable pressure mold respectively comprise:
a mold body; and
a variable pressure porous layer disposed on the mold body and correspondingly exposed to the foam molding space, wherein a plurality of variable pressure pores are disposed in the variable pressure porous layer, and the variable pressure pores connect the foam molding space;
injecting a first foaming material to the foam molding space; and
performing a foaming step, wherein the first variable pressure mold applies a first pressure to the first foaming material, the second variable pressure mold applies a second pressure to the first foaming material, and then the first foaming material is heated to form a semi-finished injection product;
wherein the first pressure and the second pressure are different, and the first pressure is a varying pressure.

2. The variable pressure controlled injection method of claim 1, wherein a diameter of each of the plurality of variable pressure pores of the first variable pressure mold is 200 μm to 700 μm, and a diameter of each of the plurality of variable pressure pores of the second variable pressure mold is 200 μm to 700 μm.

3. The variable pressure controlled injection method of claim 1, wherein the first pressure is applied as a third pressure for a duration of 1 second to 5 seconds before being increased to a fourth pressure, and the third pressure is less than the fourth pressure.

4. The variable pressure controlled injection method of claim 1, wherein the first pressure is applied as a fifth pressure for a duration of 1 second to 5 seconds before being decreased to a sixth pressure, and the fifth pressure is greater than the sixth pressure.

5. The variable pressure controlled injection method of claim 1, wherein the second pressure is a fixed pressure.

6. The variable pressure controlled injection method of claim 1, wherein the first foaming material is a rubber and plastic foaming material.

7. A semi-finished injection product manufactured by the variable pressure controlled injection method of claim 1, comprising:
a microporous layer formed at one end of the semi-finished product near the first variable pressure mold; and
a solidified layer formed at one end of the semi-finished product near the second variable pressure mold.

8. The semi-finished injection product of claim 7, wherein a foaming degree of the microporous layer is 30% to 80%, and a foaming degree of the solidified layer is 50% to 100%.

9. A co-injection product manufacturing method, comprising:
providing the semi-finished injection product of claim 7;
injecting a second foaming material onto the microporous layer of the semi-finished product to obtain a co-injection preform; and
performing a molding step, wherein the co-injection preform is heated under a stable internal pressure to completely foam and obtain a co-injection product.

10. The co-injection product manufacturing method of claim 9, wherein the second foaming material is a thermoplastic material.
